(19) United States
(12) Patent Application Publication
(10) Pub. No.: US 2012/0280460 A1
(43) Pub. Date: Nov. 8, 2012

(54) TWO-PIECE SIDE SEAL WITH COVERS

(75) Inventors: David William CIHLAR, Greenville, SC (US); William BYRNE, Simpsonville, SC (US); Patrick Benedict MELTON, Horse Shoe, NC (US)

(73) Assignee: GENERAL ELECTRIC COMPANY, Schenectady, NY (US)

(21) Appl. No.: 13/102,139

(22) Filed: May 6, 2011

(51) Int. Cl. F16J 15/02

(52) U.S. Cl. 277/637

(57) ABSTRACT

A side seal assembly is provided for sealing gaps between adjacent transition ducts in a gas turbine combustor arrangement. The side seal assembly includes a first elongated plate mounting an outer seal and a first fastening element at one end thereof; a second elongated plate mounting a second fastening element at one end thereof and an inner seal at an opposite end thereof. The first and second elongated plates are adapted to be joined in back-to-back relationship by means of the first and second fastening elements, such that in use, the outer and inner seals extend substantially parallel to, but offset from, the first and second elongated plates. The first elongated plate and the inner and outer seals substantially cover three radial gaps between the adjacent transition ducts.

### BACKGROUND

The present invention relates generally to gas turbine combustion systems, and particularly to seal assemblies used to close leakage paths at the interface between combustor transition pieces or ducts and first stage turbine nozzles.

For gas turbine systems that have an annular array of combustors about the turbine rotor, a like number of transition pieces or ducts are located between the respective combustors and the first stage nozzle assembly and feed the hot combustion gases from the combustors to the turbine.

Where the transition pieces are joined to the first stage nozzle, compressor discharge air leakage paths are created by the presence of radial gaps between adjacent transition piece aft end frames or flanges, and between adjacent transition piece end seals. Once the transition pieces are installed and bolted in place, access to the aft ends of the transition pieces is difficult. There remains a need, therefore, for a transition piece side seal assembly that is simple, easy to install and effective in terms of leakage path reduction.

### BRIEF SUMMARY OF THE INVENTION

In accordance with one exemplary but nonlimiting embodiment, there is provided a side seal assembly for sealing gaps between adjacent transition ducts in a gas turbine combustor arrangement, the side seal assembly comprising a first elongated plate mounting an outer seal and a first fastening element at one end thereof; a second elongated plate mounting a second fastening element at one end thereof and an inner seal at an opposite end thereof; wherein the first and second elongated plates are adapted to be joined in back-to-back relationship by means of the first and second fastening elements.

In another exemplary but nonlimiting embodiment, the invention provides a seal for sealing gaps between adjacent transition duct flanges in a gas turbine combustor arrangement, the seal comprising a first seal plate mounting a seal tab at one end thereof, the first seal plate having substantially parallel marginal edges adapted to be received within elongated edge grooves formed along opposed edges of the adjacent transition duct flanges; the seal tab lying forward of the first seal plate, and adapted to seal a radially outer gap between edges of adjacent aft end seals of the adjacent transition ducts.

In still another exemplary but nonlimiting embodiment, the invention provides a side seal assembly and transition duct arrangement in a gas turbine comprising at least two combustors and at least two transition ducts extending between the at least two combustors and a first turbine stage; the at least two transition ducts located adjacent one another, with adjacent transition duct flanges separated by a first radial gap and transition duct inner and outer aft end seals separated by second and third radial gaps, respectively, axially offset from the first radial gap, the side seal assembly including a first elongated plate providing a first seal, the first elongated plate mounting a second seal axially offset from the first seal, wherein the first seal covers the first radial gap, and the second seal covers the second radial gap.

The invention will now be described in detail in connection with the drawings identified below.

### BRIEF DESCRIPTION OF THE DRAWINGS

FIG. 1 is a simplified section of gas turbine transition piece located between a combustor liner at a forward end, and a first stage nozzle assembly at an opposite, aft end;

FIG. 2 is an enlarged partial perspective of radially outer aft ends of adjacent transition pieces at the interface with the first stage nozzle assembly, and showing a radially outer end of a side seal assembly in accordance with a first exemplary but nonlimiting embodiment of the invention installed between the adjacent transition pieces;

FIG. 3 is an enlarged partial perspective of radially inner aft ends of the adjacent transition pieces of FIG. 2 and showing the radially inner end of the side seal assembly;

FIG. 4 is a perspective view of an assembled side seal assembly in accordance with a first exemplary but nonlimiting embodiment of the invention as shown in FIGS. 2 and 3;

FIG. 5 is a perspective view of the outer or forward component of the side seal assembly shown in FIG. 4;

FIG. 6 is a perspective view of the inner or aft component of the side seal assembly shown in FIG. 4;

### DETAILED DESCRIPTION OF THE INVENTION

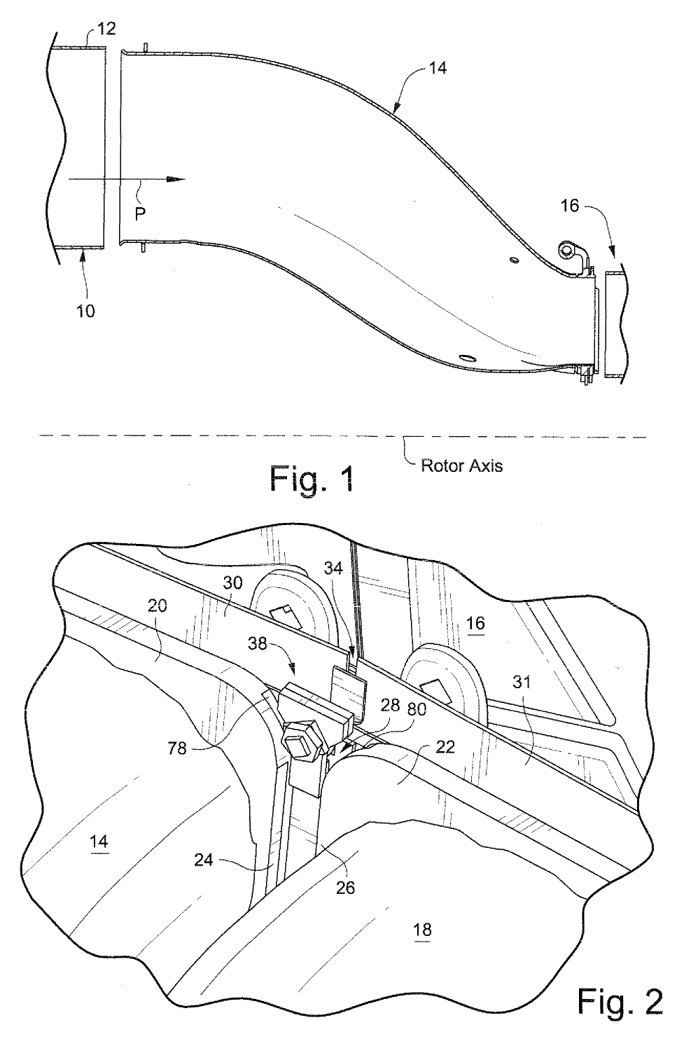

With reference initially to FIG. 1, a well-known gas turbine combustion configuration includes a combustor 10, a combustion chamber liner 12, and a transition piece 14 that supplies the hot combustion gases to the first stage nozzle 16 of the turbine. A plurality of similar combustors may be arranged in an annular array (sometimes referred to as a can-annular array), with a like plurality of transition pieces or ducts supplying the hot combustion gases to the turbine. The transition piece 14 is in the form of a hollow duct having a forward end adapted for connection to the combustion chamber liner 12 and an aft end adapted for connection to the first stage nozzle 16. The manner in which the transition piece 14 is connected at its opposite ends to the combustion chamber liner and the first stage nozzle is also well understood and needs no further discussion here.

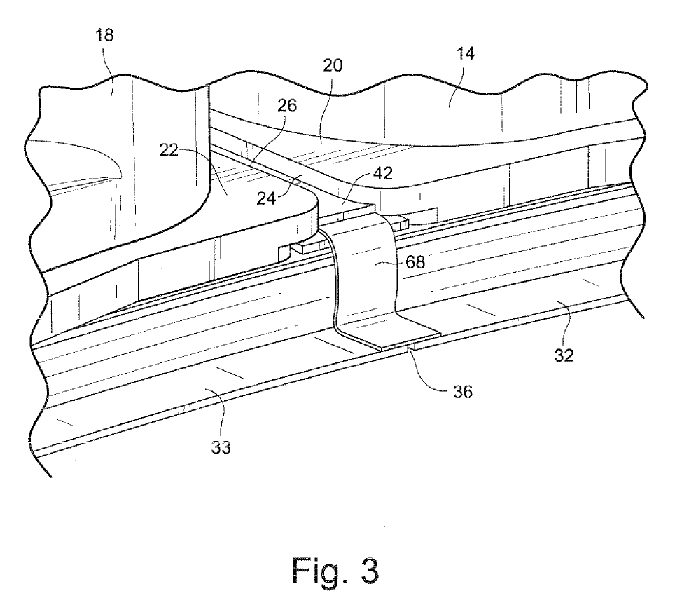

In FIGS. 2 and 3, adjacent transition pieces 14, 18 are shown with their aft ends connected to the turbine first stage nozzle 16. The transition pieces 14, 18 are provided with aft peripheral end frames or flanges 20, 22, respectively, which facilitate sealing attachment to the turbine first stage nozzle. Adjacent side edges 24, 26 of the transition piece end frames or flanges 20, 22 extend in a substantially radial direction, substantially parallel with each other, leaving a first radial gap 28 along substantially the entire depth or height dimension of the transition pieces, which provides a leakage path for compressor discharge air. Inner and outer aft end seals 30, 32 on transition piece 14 and adjacent inner and outer aft end seals 31, 33 on the adjacent transition piece 18 located forward of the peripheral end frames or flanges 20, 22, create second and third radial gaps 34 and 36, respectively, which provide additional leakage paths.

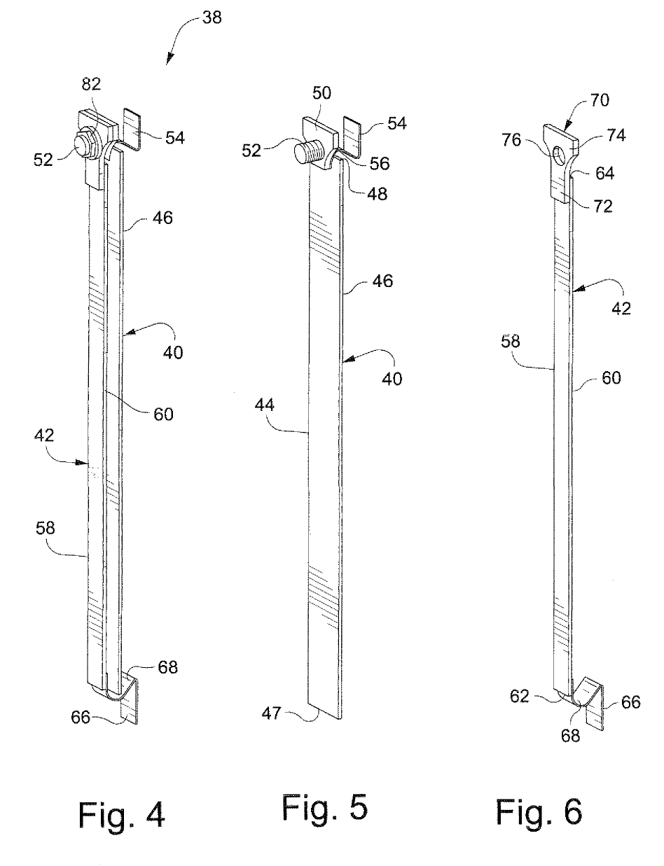

In accordance with an exemplary but nonlimiting embodiment, this invention provides a transition piece side seal assembly 38 illustrated separately in FIGS. 4-6. The side seal assembly is formed as a combination of an elongated, relatively rigid, aft seal plate or strap (or simply “plate”) 40 and an inner elongated, relatively rigid, forward seal plate or strap (or simply, “forward plate”) 42. The aft plate 40 is formed with radially-extending marginal side edges 44, 46 a radially inner edge 47 and a radially outer edge 48. A first boss or tab 50, provided with a threaded shank 52, is fastened, preferably by welding, to a radially outer end of the outer plate 40 adjacent edge 48, with a radially outer tab, or seal, 54 sandwiched between the boss 50 and the aft plate 40 by means of an integral and relatively flexible connector arm or link 56. The boss 50 tapers from a narrow end to a wider end to accommodate the shank 52, and as permitted by the curvature of flanges 20, 22 on the adjacent transition pieces.

The forward plate 42 is also elongated and substantially rectangular in shape but with a narrower width dimension than the aft plate 40. The forward plate 42 also includes radially-extending side edges 58, 60 a radially inner edge 62 and a radially outer edge 64. At the radially inner end of the forward plate 42, there is provided a lower seal tab, or seal, 66 that is welded or otherwise suitably secured thereto by means of an integral, flexible arm 68. At the radially outer end of the forward plate 42, there is a boss 70 formed to include an attachment tab portion 72, and an expanded radially outer end 74 provided with a round hole or aperture 76. Here again, the boss 70 is attached to the forward plate 42 by welding or other suitable means.

In order to install the transition piece side seal assembly 38, the aft seal plate 40 is inserted into a pair of opposed grooves 76, 78 formed in the side edges 24, 26 of the transition piece end flanges 20, 22 (FIG. 2). With the aft plate 40 thus confined between the side edges 24 and 26, it will be appreciated that the first radial gap 28 between the side edges is substantially closed along the entire height (or depth) dimension of the adjacent transition pieces 14, 18. In other words, the outer plate 40 serves as a first seal, substantially closing the first radial gap 28.

The forward plate 42 is then axially positioned such that the hole 76 is received over the threaded shank 52, with the forward plate 42 engaged along one side of the aft plate 40, in back-to-back relationship as shown in FIG. 4. A threaded nut 82 is then secured over the threaded shank 52, locking the forward and aft seal plates 40, 42 together. The radially outer and inner cover seals 54 and 66 are positioned against the inner and outer end seals 30, 32 and 31, 33 of the respective transition pieces 14, 18 to seal or substantially close the second and third radial gaps 34, 36. Thus, first, second and third seals 40, 54 and 66 substantially close respective first, second and third radial gaps 28, 34 and 36. When installed as described, the radially outer and inner seals 54, 66 lie substantially in a common plane, offset in the forward direction from a substantially parallel plane defined by the plates 40, 42. It will be appreciated that the forward and aft seal plates 40, 42 may be secured together prior to installation, the narrower width of the forward plate 42 permitting the aft plate 40 to be inserted into the grooves 78, 80 without obstruction or interference.

Variations of the above-described design are well within the scope of the invention. For example, the boss 50 and threaded shank 52 could be formed such that the boss 50 lies horizontally rather than vertically, with the threaded shank 48 then projecting vertically as opposed to horizontally. In addition, there may be instances where the radially inner cover seal 66 is not required, and in that case, the forward seal plate 42 shown in FIG. 6 could be omitted in favor of the aft seal plate 40 shown in FIG. 5. All components of the side seal assembly 38 are preferably metal or metal alloys, the specific composition of which is within the skill of the art.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A side seal assembly for sealing gaps between adjacent transition ducts in a gas turbine combustor arrangement, the side seal assembly comprising:
a first elongated plate mounting an outer seal and a first fastening element at one end thereof;
a second elongated plate mounting a second fastening element at one end thereof and an inner seal at an opposite end thereof; wherein the first and second elongated plates are adapted to be joined in back-to-back relationship by means of the first and second fastening elements.

2. The side seal assembly of claim 1 wherein, when the first and second elongated plates are joined, the outer and inner seals are offset from the first and second elongated plates.

3. The side seal assembly of claim 2 wherein the first fastening element includes a first boss provided with a threaded shank, and the second fastening element comprises a second boss provided with an aperture through which the threaded shank passes; and wherein, in use, a threaded nut is applied over the threaded shank and tightened against the second boss.

4. The side seal assembly of claim 3 wherein the outer and inner seals are attached to the first and second elongated plates by respective first and second integral, flexible arms.

5. The side seal assembly of claim 3 wherein, when the first and second elongated plates are joined, the outer and inner seals lie substantially in a common plane, offset from but substantially parallel to a second plane containing said first and second elongated plates.

6. The side seal assembly of claim 1 wherein the first elongated plate has a width dimension greater than a corresponding width dimension of the second elongated plate.

7. A seal for sealing gaps between adjacent transition duct flanges in a gas turbine combustor arrangement, the seal comprising:
a first seal plate mounting a seal tab at one end thereof, the first seal plate having substantially parallel marginal edges adapted to be received within elongated edge grooves formed along opposed edges of the adjacent transition duct flanges;
the seal tab lying forward of the first seal plate, and adapted to seal a radially outer gap between edges of adjacent aft end seals of the adjacent transition ducts.

8. The seal of claim 7 wherein the seal tab is connected to the first seal plate by a flexible arm.

9. The seal of claim 7 wherein the said seal tab is substantially parallel to the first seal plate.

10. The seal of claim 9 wherein the one end is a radially outer end.

11. The seal of claim 10 and further comprising a second seal plate engaged with the first seal plate and mounting another seal tab at a radially inner end of the second seal plate.

12. A side seal assembly and transition duct arrangement in a gas turbine comprising at least two combustors and at least two transition ducts extending between the at least two combustors and a first turbine stage; the at least two transition ducts located adjacent one another, with adjacent transition duct flanges separated by a first radial gap and transition duct inner and outer aft end seals separated by second and third radial gaps, respectively, axially offset from the first radial gap, the side seal assembly including a first elongated plate providing a first seal, the first elongated plate mounting a second seal axially offset from the first seal, wherein the first seal covers the first radial gap, and the second seal covers the second radial gap.

13. The side seal assembly and transition duct arrangement of claim 12 wherein the first elongated plate has substantially parallel marginal edges received within elongated edge grooves formed along opposed edges of the adjacent transition duct flanges.

14. The side seal assembly and transition duct arrangement of claim 13 and further comprising a second elongated plate in back-to-back relationship with the first elongated plate, the second elongated plate mounting a third seal covering the third radial gap.

15. The side seal assembly and transition duct arrangement of claim 14 wherein the first elongated plate mounts a first boss formed with a threaded shank and the second elongated plate mounts a second boss formed with an aperture, wherein the threaded shank passes through the aperture and a threaded nut is tightened against the second elongated plate to thereby secure the first elongated plate to the second elongated plate.

16. The side seal assembly and transition duct arrangement of claim 14 wherein the second and third seals are substantially co-planar.

17. The side seal assembly and transition duct arrangement of claim 16 wherein the first and second elongated plates are substantially parallel to the second and third seals.

18. The side seal assembly and transition duct arrangement of claim 12 wherein the second seal is connected to the first elongated plate by a first flexible arm.

19. The side seal assembly and transition duct arrangement of claim 18 wherein the third seal is connected to the second elongated plate by a second flexible arm.

20. The side seal assembly and transition duct arrangement of claim 14 wherein the second and third seals comprise substantially flat, metal seal tabs.
